(19) United States
(12) Patent Application Publication
(10) Pub. No.: US 2004/0238378 A1
(43) Pub. Date: Dec. 2, 2004

(54) Nox measurement device, nox sensor self-diagnosis device, and self-diagnosis method thereof

(76) Inventors: Shinji Kumazawa, Aichi (JP); Akihiro Kobayashi, Aichi (JP); Yoshinori Inoue, Aichi (JP); Norikazu Ieda, Aichi (JP); Yuji Oi, Aichi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/489,813

(22) PCT Filed: Mar. 18, 2003
(86) PCT No.: PCT/JP03/03250

(30) Foreign Application Priority Data
Mar. 29, 2002 (JP) 2002-96832

(51) Int. Cl. G01N 27/26; G01F 1/64; G01N 17/00

(52) U.S. Cl. 205/781; 204/401; 204/424

(57) ABSTRACT

Apparatus for measuring NOx concentration comprises a NOx sensor element having an oxygen partial-pressure detection cell 3 which detects oxygen concentration of an analyte gas in first measurement chamber 5, first oxygen pump cell 1 across which a current corresponding to oxygen concentration of analyte gas (“a first oxygen pump current”) flows by pumping oxygen from inside to outside of first measurement chamber 1, second measurement chamber 6 into which gas is introduced from first measurement chamber 5 via second diffusion resistance 8, and second oxygen pump cell 2 across which a current corresponding to NOx concentration (“a second oxygen pump current”) flows by transferring oxygen dissociated by decomposition of nitrogen oxide in second measurement chamber 6; and first diagnostic means 30a for diagnosing the apparatus as normally functioning if the second oxygen pump current Ip2 or a predetermined voltage Vp2 applied to second oxygen pump cell 2 is within a predetermined range, whereas as not normally functioning if the current Ip2 or the voltage Vp2 is outside predetermined range.

### TECHNICAL FIELD

The prevent invention relates to an apparatus for measuring gas concentration, an apparatus for self-diagnosing a gas sensor and a self-diagnosing method thereof, particularly, to an apparatus for measuring NOx gas concentration, an apparatus for self-diagnosing a NOx sensor and a self-diagnosing method thereof, for an on-board diagnostic system (OBD).

### BACKGROUND ART

Recent years, in dealing with intensification of exhaust gas regulations, research has been constructed into controlling an internal combustion engine and a catalyst based on a direct measurement of the NOx gas in e.g., engine exhaust gases. A NOx gas sensor in which the NOx concentration is detected based on a current generated by decomposition of the NOx by pumping out oxygen by means of an oxygen pumping cell, which uses an oxygen ion conductor such as ZrO₂, particularly has been studied in recent years since it has been considered that the NOx gas sensor could measure the NOx gas concentration without influence of disturbing gas of HC, CO and the like.

### PROBLEMS TO BE SOLVED BY THE INVENTION

The NOx sensor applied to the NOx measurement in the exhaust gas of the internal combustion engine must have high precision and always operate normally since the exhaust gas of the internal combustion engine includes extremely a less amount of NOx than oxygen and the like. An apparatus for self-diagnosing such NOx sensor, however, has not been made into practice yet.

It is an object of the present invention to provide an apparatus for measuring NOx concentration, an apparatus for self-diagnosing the NOx sensor and a self-diagnosing method thereof, which can accurately perceive a state of the NOx sensor suitably applied to the NOx measurement in the exhaust gas of the internal combustion engine and be applicable to the on-board diagnostic system.

### DISCLOSURE OF THE INVENTION

In an apparatus for measuring NOx concentration according to the present invention, a NOx sensor element comprises a first measurement chamber into which an analyte gas is introduced via a first diffusion resistance, an oxygen partial-pressure detection cell which has a pair of electrodes provided on inside and outside of the first measurement chamber and detects oxygen concentration of the analyte gas in the first measurement chamber based on a potential difference between the pair of the electrodes, a first oxygen pump cell which has a pair of electrodes provided on the inside and outside of the first measurement chamber and across which a current corresponding to the oxygen concentration of the analyte gas (referred to as “a first oxygen pump current”) flows by pumping the oxygen from the inside to the outside or vice versa of the first measurement chamber via the pair of the electrodes, a second measurement chamber into which the analyte gas is introduced from the first measurement chamber via a second diffusion resistance, and a second oxygen pump cell which has a pair of electrodes provided on the inside and outside of the second measurement chamber and across which a current corresponding to NOx concentration (referred to as “a second oxygen pump current”) flows across the pair of the electrodes by transferring oxygen dissociated by decomposition of nitrogen oxide in the second measurement chamber.

The apparatus for measuring the NOx concentration according to the present invention has means for controlling the oxygen partial-pressure detection cell which controls the oxygen concentration at the electrode provided on the outside of the oxygen partial-pressure detection cell, means for controlling the first oxygen pump cell which controls the oxygen concentration in the first measurement chamber by controlling the first oxygen pump current by application of a predetermined voltage to the first oxygen pump cell based on an output detected by the oxygen partial-pressure detection cell, and means for controlling the second oxygen pump cell so as to cause the second oxygen pump current corresponding to the NOx concentration to flow by applying a predetermined voltage to the second oxygen pump cell, as means for controlling the NOx sensor element.

A fixed voltage is applied to the second oxygen pump cell so as to flow a current, which is proportional to the NOx concentration, across the second oxygen pump cell in a normal measuring mode of the apparatus for measuring the NOx concentration according to the present invention. Moreover, the gas, in which the oxygen concentration is controlled by the first oxygen pump cell, is introduced into the second measurement chamber. Therefore, the extent of the second oxygen pump current and the voltage actually applied to the second oxygen pump cell must be within a predetermined range, respectively, in case where the NOx sensor element or the controlling means thereof functions normally. Accordingly, a functioning state of the NOx sensor element or of the controlling means thereof can be diagnosed by the following diagnostic means in the apparatus for measuring the NOx concentration according to the present invention.

Namely, according to a first aspect, the present invention provides an apparatus for measuring the NOx concentration further having detection means for detecting a second oxygen pump current or a voltage applied to the second oxygen pump cell, and diagnostic means for diagnosing the apparatus for measuring the NOx concentration as normally functioning in case where the detected second oxygen pump current or the detected predetermined voltage applied to the second oxygen pump cell is within a predetermined range, whereas as not normally functioning in case where the current or the voltage is outside the predetermined range, in addition to the NOx sensor element and the controlling means thereof, which are a fundamental constitution as described above.

This apparatus for measuring the NOx concentration diagnoses whether the NOx sensor is normally functioning or not, by means of the second oxygen pump current which is a detection output signal of the NOx sensor or a voltage applied to the second oxygen pump cell across which the second oxygen pump current flows. The second oxygen pump current has a very low range since the exhaust gas of the internal combustion engine includes a very little NOx concentration. In addition, the second oxygen pump current changes in accordance with e.g., temperature of the element, an active state of the electrode, resistance of the lead wire, etc. since the magnitude of the second oxygen pump current is sensitive to the state of the NOx sensor element or of the controlling means thereof. Accordingly, it is possible to very sharply detect the state of the apparatus for measuring the NOx concentration by using the second oxygen pump current. For the same reason, it is also possible to very sensitively detect the state of the apparatus for measuring the NOx concentration by detecting the state of the NOx sensor element by means of the voltage applied to the second oxygen pump cell.

In this way, the apparatus for measuring the NOx concentration according to the present invention can sensitively detect the state of the NOx sensor element or the controlling means thereof. Accordingly, the apparatus for measuring the NOx concentration according to the present invention is suitable for use in a field which requires high reliance, in particular, the apparatus for measuring the NOx concentration in the exhaust gas of an onboard internal combustion engine. Moreover, an ECU of controlling the internal combustion engine can perform an onboard diagnosis (OBD) based on a diagnostic result by the diagnostic means in the apparatus for measuring the NOx concentration according to the present invention. For example, the ECU can judge the state of the NOx sensor element mounted to an exhaust pipe or of a controlling means thereof, based on the diagnostic result, and besides, diagnose the state of an element which constitutes a fuel system, an inspiration system, an exhaust system and the like.

In the apparatus for measuring the NOx concentration according to the present invention, moreover, the oxygen concentration on an electrode of the oxygen partial-pressure detection cell, disposed outside the first measurement chamber, is usually controlled at a constant value. On the other hand, the oxygen concentration on an electrode of the oxygen partial-pressure detection cell, disposed inside of the first measurement chamber, is equal to an atmospheric oxygen concentration or below in the usual measurement. Accordingly, the voltage applied to the oxygen partial-pressure detection cell, the electrical potential of the outside electrode of the oxygen partial-pressure detection cell and the internal resistance of the oxygen partial-pressure detection cell ought to be within a predetermined range in case where the NOx sensor element or the controlling means thereof functions normally. Therefore, the apparatus for measuring the NOx concentration according to the present invention can diagnose the state of the function of the NOx sensor element or of the controlling means thereof by a diagnostic means described below.

Namely, according to a second aspect, the present invention provides an apparatus for measuring the NOx concentration further having detection means for detecting a voltage applied to an oxygen partial-pressure detection cell, and diagnostic means for diagnosing the apparatus for measuring the NOx concentration as normally functioning in case where the detected voltage applied to the oxygen partial-pressure detection cell is within a predetermined range, whereas as not normally functioning in case where the voltage is outside the predetermined range, in addition to the above fundamental constitution.

According to a third aspect, the present invention provides an apparatus for measuring the NOx concentration further having detection means for detecting electric potential at an inside electrode of an oxygen partial-pressure detection cell, and diagnostic means for diagnosing the apparatus for measuring the NOx concentration as normally functioning in case where the detected electric potential at the inside electrode of the oxygen partial-pressure detection cell is within a predetermined range, whereas as not normally functioning in case where the electric potential is outside the predetermined range, in addition to the above fundamental constitution.

According to a fourth aspect, the present invention provides an apparatus for measuring the NOx concentration further having detection means for detecting the internal resistance of an oxygen partial-pressure detection cell, and diagnostic means for diagnosing the apparatus for measuring the NOx concentration as normally functioning in case where the detected internal resistance of the oxygen partial-pressure detection cell is within a predetermined range, whereas as not normally functioning in case where the internal resistance is outside the predetermined range, in addition to the above fundamental constitution.

The oxygen concentration in the analyte gas is equal to the atmospheric oxygen concentration or below in the usual measurement of the apparatus for measuring the NOx concentration according to the present invention. Accordingly, the magnitude of the first oxygen pump current controlled in feedback based on the detection output of the oxygen concentration of the oxygen partial-pressure detection cell and the voltage actually applied to the first oxygen pump cell ought to be within the predetermined range, respectively, in case where the NOx sensor element or the controlling means thereof functions normally. Therefore, the apparatus for measuring the NOx concentration according to the present invention can diagnose the state of the function of the NOx sensor element or of the controlling means thereof by a diagnostic means described below.

Namely, according to a fifth aspect, the present invention provides an apparatus for measuring the NOx concentration further having detection means for detecting a first oxygen pump current or a voltage applied to the first oxygen pump cell, and diagnostic means for diagnosing the apparatus for measuring the NOx concentration as normally functioning in case where the detected first oxygen pump current or the detected predetermined voltage applied to the first oxygen pump cell is within a predetermined range, whereas as not normally functioning in case where the current or the voltage is outside the predetermined range, respectively, in addition to the above fundamental constitution.

According to a sixth aspect, the present invention provides an apparatus for measuring the NOx concentration wherein the apparatus is used for measuring the NOx concentration in the exhaust gas of the internal combustion engine.

According to a seventh aspect, the present invention provides an apparatus for measuring the NOx concentration wherein the apparatus is used for measuring the NOx concentration in the exhaust gas of an internal combustion engine loaded on a vehicle, and wherein the onboard diagnosis (OBD) is performed by using a diagnostic result of at least the diagnostic means.

Moreover, according to an eighth aspect, the present invention provides an apparatus for self-diagnosing the NOx sensor comprising a NOx sensor element having a first measurement chamber into which an analyte gas is introduced via a first diffusion resistance, an oxygen partial-pressure detection cell which has a pair of electrodes provided on the inside and outside of the first measurement chamber and detects the oxygen concentration of the analyte gas in the first measurement chamber based on a potential difference between the pair of the electrodes, the first oxygen pump cell which has a pair of electrodes provided on the inside and outside of the first measurement chamber and across which the current corresponding to the oxygen concentration of the analyte gas (referred to as “the first oxygen pump current”) flows by pumping oxygen from the inside to the outside or vice versa of the first measurement chamber via the pair of the electrodes, a second measurement chamber into which the analyte gas is introduced from the first measurement chamber via a second diffusion resistance, and a second oxygen pump cell which has a pair of electrodes provided on the inside and outside of the second measurement chamber and across which the current corresponding to the NOx concentration (referred to as “the second oxygen pump current”) flows across the pair of the electrodes by transferring oxygen dissociated by decomposition of nitrogen oxide in the second measurement chamber; and means for controlling the NOx sensor element having means for controlling the oxygen partial-pressure detection cell which controls the oxygen concentration at the electrode provided on the outside of the oxygen partial-pressure detection cell, means for controlling the first oxygen pump cell which controls the oxygen concentration in the first measurement chamber by controlling the first oxygen pump current by application of a predetermined voltage to the first oxygen pump cell based on an output detected by the oxygen partial-pressure detection cell, means for controlling the second oxygen pump cell so as to cause the second oxygen pump current corresponding to the NOx concentration to flow by applying a predetermined voltage to the second oxygen pump cell, detection means for detecting a second oxygen pump current or a voltage applied to the second oxygen pump cell, and diagnostic means which diagnoses the apparatus for measuring the NOx concentration as normally functioning in case where the detected second oxygen pump current or the detected predetermined voltage applied to the second oxygen pump cell is within a predetermined range, whereas as not normally functioning in case where the current or the voltage is outside the predetermined range.

According to a ninth aspect, moreover, the present invention provides a method for self-diagnosing an apparatus for measuring the NOx concentration comprising the NOx sensor element having a first measurement chamber into which an analyte gas is introduced via a first diffusion resistance, an oxygen partial-pressure detection cell which has a pair of electrodes provided on the inside and outside of the first measurement chamber and detects oxygen concentration of the analyte gas in the first measurement chamber based on a potential difference between the pair of the electrodes; a first oxygen pump cell which has a pair of electrodes provided on the inside and outside of the first measurement chamber and across which a current corresponding to the oxygen concentration of the analyte gas (referred to as “the first oxygen pump current”) flows by pumping the oxygen from the inside to the outside or vice versa of the first measurement chamber via the pair of the electrodes, a second measurement chamber into which the analyte gas is introduced from the first measurement chamber via a second diffusion resistance, and a second oxygen pump cell which has a pair of electrodes provided on the inside and outside of the second measurement chamber and across which a current corresponding to the NOx concentration (referred to as “the second oxygen pump current”) flows across the pair of the electrodes by transferring oxygen dissociated by decomposition of nitrogen oxide in the second measurement chamber; and means for controlling the NOx sensor element having means for controlling the oxygen partial-pressure detection cell which controls the oxygen concentration at the electrode provided on the outside of the oxygen partial-pressure detection cell, means for controlling the first oxygen pump cell which controls the oxygen concentration in the first measurement chamber by controlling the first oxygen pump current by application of a predetermined voltage to the first oxygen pump cell based on the output detected by the oxygen partial-pressure detection cell, means for controlling the second oxygen pump cell so as to cause the second oxygen pump current corresponding to the NOx concentration to flow by applying a predetermined voltage to the second oxygen pump cell, and detection means for detecting the second oxygen pump current or a voltage applied to the second oxygen pump cell, wherein the means for controlling the NOx sensor element diagnoses the apparatus for measuring the NOx concentration as normally functioning in case where the detected second oxygen pump current or the detected predetermined voltage applied to the second oxygen pump cell is within a predetermined range, whereas as not normally functioning in case where the current or the voltage is outside the predetermined range.

According to a tenth aspect, the present invention provides an apparatus for measuring the NOx concentration which comprises the NOx sensor element having oxygen pump cells, a NOx detection cell and an oxygen partial-pressure detection cell, generates a gas in which oxygen partial-pressure is controlled from the analyte gas having an oxygen concentration and a nitrogen oxide concentration within a predetermined range, respectively, by the first oxygen pump cell and the oxygen partial-pressure detection cell, and measures the nitrogen oxide concentration in the analyte gas based on a limiting current to be flowed across the NOx detection cell contacting the gas whose oxygen partial-pressure is controlled, wherein the apparatus for measuring the NOx concentration comprises means for detecting abnormality which detects abnormality of the first oxygen pump cell, the NOx detection cell and the oxygen partial-pressure detection cell, and changing means for causing the apparatus for measuring the NOx concentration to output a predetermined signal whose level or order corresponds to the nitrogen oxide concentration within a predetermined range in the analyte gas in case where no abnormality is detected by the means for detecting the abnormality, whereas for changing the level or order of the predetermined signal in case where the abnormality of the apparatus for measuring the NOx concentration is detected by the means for detecting the abnormality.

According to an eleventh aspect, the present invention provides an apparatus for measuring the NOx concentration, wherein an analyte gas includes an oxygen concentration within a predetermined range, and wherein the changing means further causes the apparatus for measuring the NOx concentration to output a predetermined signal whose level or order corresponds to the oxygen concentration within the predetermined range in the analyte gas in case where no abnormality is detected by the means for detecting the abnormality, whereas the changing means change the level or order of a predetermined signal in case where the abnormality is detected by the means for detecting the abnormality.

According to a twelfth aspect, the present invention provides an apparatus for the NOx concentration, wherein the means for detecting the abnormality further detects abnormality of wiring connecting with the first oxygen pump cell, the NOx detection cell and the oxygen partial-pressure detection cell, and wherein the changing means causes the apparatus for measuring the NOx concentration to output a predetermined signal whose level or order corresponds to the nitrogen oxide concentration within the predetermined range in the analyte gas in case where no abnormality of the wiring is detected by the means for detecting the abnormality, whereas the changing means change at least in the level or order of the predetermined signal in case where the abnormality of the wiring is detected by the means for detecting the abnormality.

According to a thirteenth aspect, the present invention provides an apparatus for measuring the NOx concentration, wherein the means for detecting the abnormality detects the abnormality of the level or order of any one or more selected from the group of: cell resistance of the oxygen partial-pressure detection cell whose resistance changes by temperature of the NOx sensor element and/or the electrical potential of the electrode of the oxygen partial-pressure detection cell, voltage applied to the first oxygen pump cell and/or current flowing across the first oxygen pump cell, and voltage applied to the second oxygen pump cell and/or current flowing across the second oxygen pump cell.

According to a fourteenth aspect, the present invention provides an apparatus for measuring the NOx concentration, wherein the changing means is formulated so as to change levels or orders of a plurality of the predetermined signals output by the apparatus for measuring the NOx concentration, and wherein an abnormal part and/or an abnormal state of the apparatus for measuring the NOx concentration are/is reported by a combination of the plurality of the predetermined signals.

According to a fifteenth aspect, the present invention provides an apparatus for measuring the NOx concentration, wherein the apparatus for measuring the NOx concentration is mounted on an onboard system in order to measure the nitrogen oxide concentration in exhaust gas, and wherein the means for detecting the abnormality and the changing means are located on a side of a controlling device in the onboard system.

According to a sixteenth aspect, the present invention provides an apparatus for measuring the NOx concentration wherein the oxygen pump cell and the oxygen partial-pressure detection cell are disposed facing space in a first chamber, and wherein the NOx detection cell is disposed facing space in a second chamber; and further provides an apparatus for measuring the NOx concentration wherein an oxygen pump cell is disposed facing the space in the first chamber, and wherein the oxygen partial-pressure detection cell and the NOx detection cell are disposed facing the space of the second chamber.

According to a seventeenth aspect, the present invention provides an apparatus for measuring the NOx concentration which comprises a NOx sensor element having oxygen pump cells, a NOx detection cell and an oxygen partial-pressure detection cell, generates a gas in which oxygen partial-pressure is controlled from the analyte gas having an oxygen concentration and a nitrogen oxide concentration within a predetermined range, respectively, controlled by the first oxygen pump cell and the oxygen partial-pressure detection cell, and measures the nitrogen oxide concentration in the analyte gas based on a limiting current to be flowed across the NOx detection cell contacting the gas whose oxygen partial-pressure is controlled, wherein the apparatus comprises means for detecting abnormality to detect an abnormal part of the apparatus for measuring the NOx concentration, and changing means, in case of the abnormality of the apparatus for measuring the NOx concentration, for changing a level or order of one or more of analog signals output at a predetermined level or order in the normal case into a level or order which is not used in the normal case, thereby reporting the abnormal part of the apparatus for measuring the NOx concentration detected by the means for detecting the abnormality.

According to a eighteenth aspect, the present invention provides an apparatus for measuring the NOx concentration which comprises a NOx sensor element having oxygen pump cells, a NOx detection cell and an oxygen partial-pressure detection cell, generates a gas in which oxygen partial-pressure is controlled from the analyte gas having an oxygen concentration and a nitrogen oxide concentration within a predetermined range, respectively, controlled by the first oxygen pump cell and the oxygen partial-pressure detection cell, and measures the nitrogen oxide concentration in the analyte gas based on a limiting current to be flowed across the NOx detection cell contacting the gas whose oxygen partial-pressure is controlled, wherein the apparatus comprises means for detecting abnormality to detect an abnormal part of the apparatus for measuring the NOx concentration, and changing means, in case of the abnormality of the apparatus for measuring the NOx concentration, for changing a code of a digital signal output at a code within a predetermined range in normal case into a code which is not used in the normal case, thereby reporting the abnormal part of the apparatus for measuring the NOx concentration detected by the means for detecting the abnormality.

According to a nineteenth aspect, the present invention provides an apparatus for measuring the NOx concentration, wherein a NOx sensor in which a NOx detection cell is an oxygen concentration cell (an electrochemical cell) is used.

According to a twentieth aspect, the present invention provides the method for self-diagnosing the apparatus for measuring the NOx concentration, wherein the apparatus comprises a NOx sensor element having oxygen pump cells, a NOx detection cell and an oxygen partial-pressure detection cell, generates the gas in which the oxygen partial-pressure is controlled from an analyte gas having an oxygen concentration and a nitrogen oxide concentration within a predetermined range, respectively, controlled by the first oxygen pump cell and the oxygen partial pressure detection cell, and measures the nitrogen oxide concentration in the analyte gas based on a limiting current to be flowed across the NOx detection cell contacting a gas whose oxygen partial-pressure is controlled, or on electric potential of the NOx detection cell, and wherein a predetermined signal corresponding to the nitrogen oxide concentration within a predetermined range in the analyte gas is output in case where the apparatus for measuring the NOx concentration is normal, whereas at least the predetermined signal is changed based on a predetermined manner, followed by reporting an abnormal part of the apparatus for measuring the NOx concentration in case where abnormality of the apparatus for measuring the NOx concentration is detected.

### BRIEF DESCRIPTION OF DRAWINGS

FIGS. 1(A)-(D) explain constitution and a measuring principle of a NOx sensor element, which is a constitutional element of an apparatus for measuring NOx concentration according to one embodiment of the present invention.

FIG. 2 explains constitution of an input and output of controlling means including diagnostic means of the apparatus for measuring the NOx concentration shown in FIG. 1(A).

FIG. 3 explains constitution of diagnostic means contained in the controlling means of the sensor shown in FIG. 2.

FIG. 4 explains a method for measuring internal resistance of the oxygen partial-pressure detection cell shown in FIG. 1 or a potential difference in oxygen partial-pressure detection.

FIG. 5(A) is a schematic diagram to explain constitution of an apparatus for measuring NOx concentration to which the present invention is applied. FIG. 5(B) is a schematic diagram to explain internal constitution of a detection part shown in FIG. 5(A).

FIG. 6 explains an example of constitution of a NOx output range in an apparatus for measuring NOx concentration according to a third embodiment of the present invention.

FIG. 7 explains an example of constitution of a plurality of signals in an apparatus for measuring NOx concentration according to a fifth embodiment of the present invention.

FIG. 8 is a schematic diagram to explain a circuit constitution of an apparatus for measuring NOx concentration according to a sixth embodiment of the present invention.

FIG. 9 explains constitution of each means for detecting abnormality which applies to the apparatus for measuring the NOx concentration shown in FIG. 8.

FIG. 10 shows a corresponding combination of electrical potential of each terminal and a kind of abnormality in an apparatus for measuring NOx concentration according to an eighth embodiment of the present invention.

FIG. 11 explains a range of the electrical potential of each terminal shown in FIG. 10.

FIG. 12 explains one example of the circuit constitution of the means for detecting the abnormality and changing means applied to the apparatus for measuring the NOx concentration shown in FIG. 8.

FIG. 13 shows the relation between an input signal and an output signal of the circuit shown in FIG. 12.

### PREFERRED EMBODIMENTS OF THE INVENTION

An apparatus for measuring NOx concentration according to a preferred embodiment of the present invention diagnoses a state of a NOx sensor based on any one or more of a first pump current, a voltage applied to a first pump cell, electrical potential of each electrode in the first pump cell or a voltage of each terminal connected with each electrode, a second pump current, a voltage applied to a second pump cell, electrical potential of each electrode in the second pump cell or a voltage of each terminal connected with each electrode, internal resistance of an oxygen partial-pressure detection cell, potential difference between electrodes in the oxygen partial-pressure detection cell, and electrical potential of each electrode in the oxygen partial-pressure detection cell (for example, the electrical potential of the electrode in the oxygen partial-pressure detection cell inside a first measurement chamber).

The present invention is also applicable to the NOx sensor element in which the oxygen pump cell (the first oxygen pump cell) is disposed facing a space in the first chamber and in which the NOx detection cell (the second oxygen pump cell) and the oxygen partial-pressure detection cell are disposed facing space in the second chamber. Further, the present invention is also applicable to the case where the NOx detection cell is an oxygen concentration cell (an electrochemical cell).

Embodiments

One embodiment of the present invention will be described hereinafter referring to drawings so that the preferred embodiments according to the present invention as described hereinbefore are further clarified.

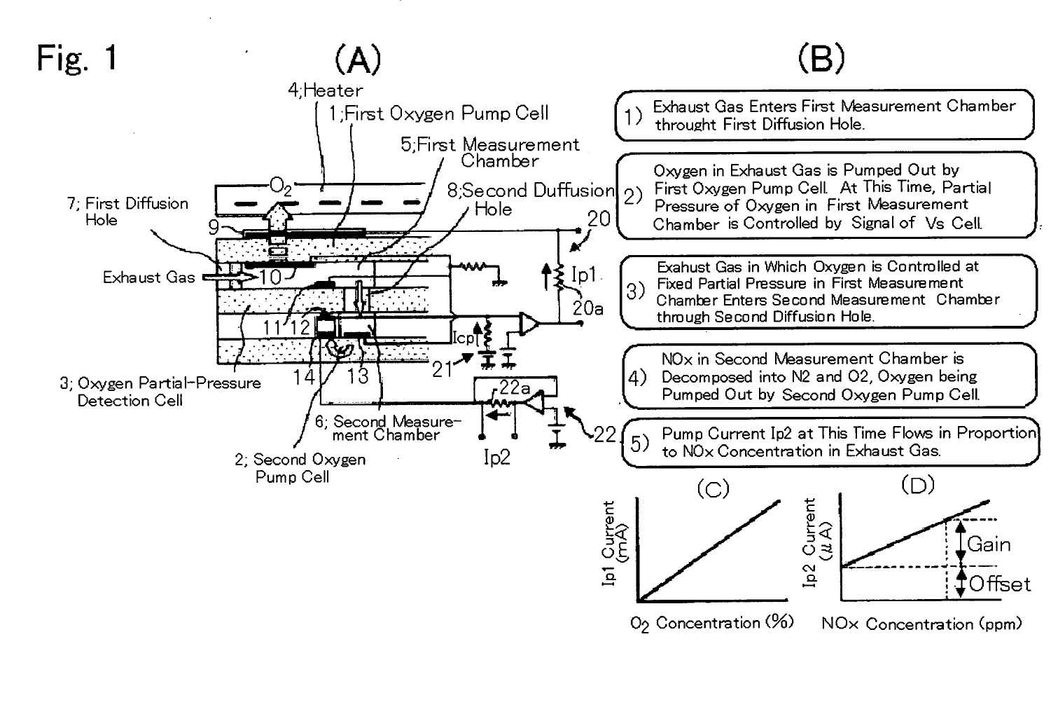

FIGS. 1(A)-(D) are figures to explain the constitution and measuring principle of a NOx sensor element which is a constitutional element of an apparatus for measuring NOx concentration according to one embodiment of the present invention.

The constitution of the NOx sensor element will be described.

Referring to FIG. 1(A), the NOx sensor element mainly comprises a first oxygen pump cell 1 (an oxygen pump cell), a second oxygen pump cell 2 (a NOx detection cell), an oxygen partial-pressure detection cell 3 and a heater 4 for heating the NOx sensor element into a predetermined operational temperature. A first measurement chamber 5 is located between the first oxygen pump cell 1 and the oxygen partial-pressure detection cell 3. An analyte gas is introduced into the first measurement chamber 5 via a first diffusion hole 7. The first measurement chamber 5 communicates with a second measurement chamber 6 through a second diffusion hole 8.

The first oxygen ion pump cell 1 comprises a solid electrolyte having oxygen ion conductivity like zirconia and a pair of electrodes 9, 10 disposed on the solid electrolyte. The electrode 10 is disposed facing the first measurement chamber 5, the electrode 9 being disposed facing the exterior. Oxygen ions generated by dissociation of oxygen and the like on the electrode 10 in the first measurement chamber 5 travel from the electrode 9 to the exterior through the solid electrolyte, and a current, at that time, flowing across the solid electrolyte is termed a first oxygen pump current Ip1.

The second oxygen ion pump cell 2 comprises a solid electrolyte with the oxygen ion conductivity like zirconia and a pair of electrodes 13, 14 disposed on the solid electrolyte. The electrode 13 is disposed facing the second measurement chamber 6, and the electrode 14 is disposed outside the second measurement chamber 6 and exposed to atmosphere of a stable oxygen concentration. The oxygen ions generated by dissociation of NOx and the like on the electrode 13 in the second measurement chamber 6 travel from the electrode 14 to the outside through the solid electrolyte, and a current, at that time, flowing across the solid electrolyte is termed a second oxygen pump current Ip2. Certain voltage is applied across the electrode 13 and the electrode 14 in a mode of usual measurement.

The oxygen partial-pressure detection cell 3 comprises a solid electrolyte with oxygen ion conductivity like zirconia and a pair of electrodes 11, 12 disposed on the solid electrolyte. The electrode 11 is disposed facing the first measurement chamber 5, the electrode 12 being exposed to atmosphere of a stable oxygen concentration. Therefore, the oxygen concentration in the first measurement chamber 5, i.e., the oxygen concentration in the analyte gas can be detected based on a potential difference generated between the electrode 11 and the electrode 12.

Next, means for controlling the NOx sensor (referring to FIG. 2) will be described. By the way, means for controlling the sensor 30 in the figure functions as both the means for controlling the NOx sensor and diagnostic means of the apparatus for measuring the NOx concentration.

Referring to FIG. 1(A), the means for controlling the sensor 30 (referring to FIG. 2) comprises means for controlling an oxygen partial-pressure cell 21 which detects oxygen concentration measured by the oxygen partial-pressure detection cell 3 in the measurement chamber 5 and controls the oxygen concentration on the electrode 12 disposed outside the first measurement chamber 5, means for controlling the first oxygen pump cell 20 which controls the oxygen concentration in the first measurement chamber 5 as fixed as possible by controlling the first oxygen pump current Ip1 based on a detection output of the oxygen partial-pressure detection cell 3 and means for controlling the second oxygen pump cell 22 which controls the second oxygen pump cell 2 so as to flow the second oxygen pump current Ip2 corresponding to the NOx concentration by applying a predetermined voltage as fixed as possible to the second oxygen pump cell 2.

As for NOx measuring principle using the NOx sensor element and the controlling means thereof as described hereinbefore, refer to FIGS. 1(B)-(D).

Next, the diagnostic means of the apparatus for measuring the NOx concentration will be described.

FIG. 2 is a figure to explain constitution of an input and output of the means for controlling the sensor 30.

Referring to FIG. 2, the first oxygen pump current Ip1 and the second oxygen pump current Ip2 output by the NOx sensor element shown in FIG. 1(A) and the oxygen partial-pressure detection potential (the potential difference between the electrode 11 and the electrode 12) Vs are input to the means for controlling the sensor 30. The first oxygen pump current Ip1, the second oxygen pump current Ip2 and the oxygen partial-pressure detection potential Vs may be input into a controlling apparatus of an internal combustion engine (referred to as “ECU”) 31. A detection signal of the NOx concentration or a required signal such as a detection signal of the oxygen concentration, and a signal showing a diagnostic result of the NOx sensor element or the controlling means thereof (referred to as “a signal for OBD”) are output from the means for controlling the sensor 30 and input into the ECU 31.

Next, the diagnostic means of the apparatus for measuring the NOx concentration in the means for controlling the sensor 30 will be described.

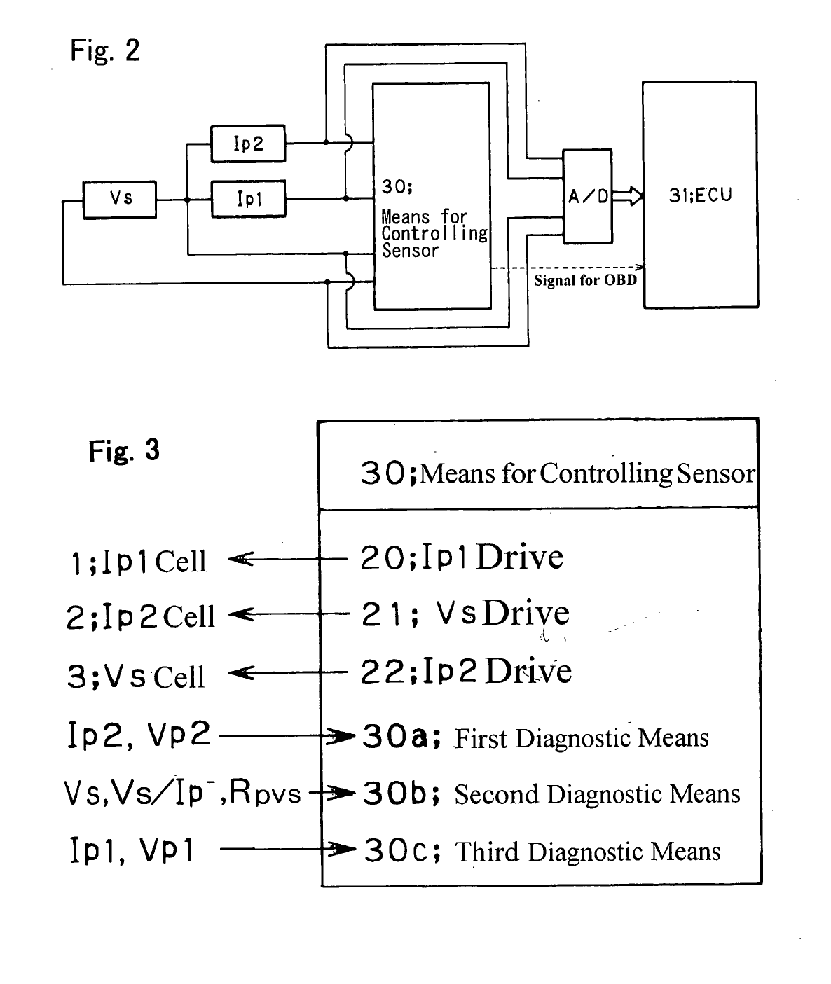

FIG. 3 is a figure to explain constitution of the diagnostic means in the means for controlling the sensor 30 shown in FIG. 2.

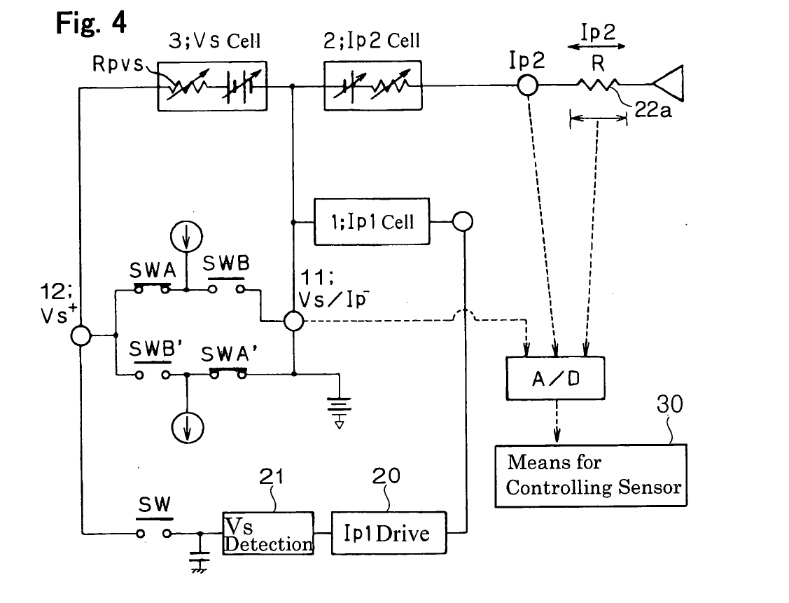

Referring to FIG. 3, the diagnostic means in the means for controlling the sensor 30 comprises a first diagnostic means 30a for diagnosing the apparatus for measuring the NOx concentration as normally functioning in case where the second oxygen pump current Ip2 or a predetermined voltage Vp2 (which is usually fixed) applied to the second oxygen pump cell is within a predetermined range, respectively, whereas as not normally functioning in case where the current Ip2 or the voltage Vp2 is outside the predetermined range, respectively, a second diagnostic means 30b for diagnosing the apparatus for measuring the NOx concentration as normally functioning in case where any one or more of the predetermined voltage Vs applied to the oxygen partial-pressure detection cell 3, an electrical potential (a potential difference between the electrode 11 and an imaginary ground shown in FIG. 4 below) of the electrode (the Vs/Ip− electrode) 11 in the oxygen partial-pressure detection cell 3 and internal resistance Rpvs of the oxygen partial-pressure detection cell 3 is/are within a predetermined range (or ranges), whereas as not normally functioning in case where any one or more of them is/are outside the predetermined range (or ranges) and a third diagnostic means 30c for diagnosing the apparatus for measuring the NOx concentration as normally functioning in case where the first oxygen pump current Ip1 or a predetermined voltage Vp1 (which is usually within a predetermined range) applied to the first oxygen pump cell is within a predetermined range, whereas as not normally functioning in case where the current Ip1 or the voltage Vp1 is outside the predetermined range.

<Detection Means for Measuring the Second Oxygen Pump Current and the Voltage Applied to the Second Oxygen Pump Cell>

The second oxygen pump current Ip2 or the predetermined voltage Vp2 applied to the second oxygen pump cell 2 can be detected by measuring a current flowing across a detection resistance 22a (referring to FIG. 1(A) or FIG. 4) in the means for controlling the second oxygen pump cell 22 and a voltage between both ends of the resistance. Besides, the predetermined voltage Vp2, applied to the second oxygen pump cell 2 is more precisely obtained from the potential difference between the electrode 13 and the electrode 14 (referring to FIG. 4).

<Detection Means for Measuring the First Oxygen Pump Current and the Voltage Applied to the First Oxygen Pump Cell>

The first oxygen pump current Ip1 or the predetermined voltage Vp1 applied to the first oxygen pump cell 1 can be detected by measuring a current flowing across a detection resistance 20a in the means for controlling the first oxygen pump cell and a voltage between both ends of the resistance.

<Means for Detecting the Internal Resistance of the Oxygen Partial-Pressure Detection Cell, and the Like>

FIG. 4 is a figure to explain a method for measuring the internal resistance of the oxygen partial-pressure detection cell shown in FIG. 1 or the potential difference of the oxygen partial-pressure detection. Referring to FIG. 4, the potential difference between the electrode 12 and the electrode 11 is measured by turning SW on and turning SWA, SWB, SWA′ and SWB′ off in case where the potential difference of the oxygen partial-pressure detection Vs is detected. On the other hand, the internal resistance Rpvs is obtained from a pulse wave generated between the electrode 11 and the electrode 12 by turning SWA and SWA′ on and SW, SWB and SWB′ off after turning SWB and SWB′ on and SW, SWA and SWA′ off in case where the internal resistance Rpvs of the oxygen partial-pressure detection cell 3 is detected. The electrical potential of the electrode (the Vs/Ip− electrode) 11 is detected by an A/D converter into which the potential difference between the electrode 11 and the imaginary ground shown in FIG. 4 below is input and is input into the means for controlling the sensor 30 having the second diagnostic means 30b shown in FIG. 2.

The means for controlling the sensor 30 diagnoses whether the apparatus for measuring the NOx concentration functions normally or not by using, for example, the second oxygen pump current Ip2, which is the detection output signal of the NOx sensor element, or a voltage Vp2 applied to the second oxygen pump cell 2. The second oxygen pump current has a very low range since the NOx concentration in the exhaust gas of the internal combustion engine is very low, i.e., an order of ppm. The concentration changes when, for example, the temperature of the element, an activated state of the electrode or a state of lead wire resistance changes. Therefore, it is possible to sensitively detect a state of the apparatus for measuring the NOx concentration by detecting the state of the NOx sensor by means of the second oxygen pump current Ip2. A range of the voltage applied to the second oxygen pump cell 2 can be also obtained at very high precision, i.e., an order of mV. Accordingly, it is also possible to achieve the state of the very high precision by detecting the state of the NOx sensor by means of the voltage Vp2 applied to the second oxygen pump cell 2. Meanwhile, breaking of a controlling wire or a signal wire of the NOx sensor element can be also detected based on the diagnostic result of the first diagnostic means. Moreover, the state of the NOx sensor can be detected by the second diagnostic means 30b or the third diagnostic means 30c, respectively. Further it is possible to more precisely self-diagnose the apparatus for measuring the NOx concentration by means of the combination of the first diagnostic means 30a and these means.

[Second Embodiment]

FIG. 5(A) is a schematic diagram to explain constitution of the apparatus for measuring the NOx concentration to which the present invention is applied. FIG. 5(B) is a schematic diagram to explain internal constitution of a detection part shown in FIG. 5(A).

Referring to FIG. 5(A) and FIG. 5(B), the apparatus for measuring the NOx concentration comprises a detection part (unit) 32 including the A/D converter and other circuits in order to detect the second oxygen pump current Ip2 and the voltage Vp2 applied to the second oxygen pump cell 2.

The detection part 32 comprises means (unit) for detecting abnormality 32a in the apparatus for measuring the NOx concentration and changing means (unit) 32b for causing the apparatus for measuring the NOx concentration to output a predetermined signal whose level or order corresponds to the oxygen concentration and the nitrogen oxide concentration within a predetermined range, respectively, in the analyte gas in case where no abnormality of the apparatus for measuring the NOx concentration is detected by the means (unit) for detecting the abnormality 32a, whereas for changing the level or order of the predetermined signal in case where the abnormality of the apparatus for measuring the NOx concentration is detected by the means for detecting the abnormality 32a. By the way, the circuit of the detection part 32 is designed so as to output the second oxygen pump current Ip2 at the order of nA-μA and the voltage Vp2 applied to the second oxygen pump cell 2 at the order of mV from an outputting means 32c in a normal case.

Accordingly, a detection signal of the abnormality is transmitted from the means for detecting the abnormality 32a in case where the means for detecting the abnormality 32a detects generation of the abnormality in the apparatus for measuring the NOx concentration, and the changing means 32b which receives the detection signal of the abnormality causes the outputting means (unit) 32c to output the changed level or order of the output signal of the apparatus for measuring the NOx concentration.

The abnormality of a wire between an Ip2 cell of the NOx sensor element, which is a constitutional element of the apparatus for measuring the NOx concentration, and the means for controlling the NOx sensor element, e.g. a short circuit of a battery or a short circuit of (or to) ground, can be directly detected by constituting the detection part 32 so as to output, e.g., the second oxygen pump current Ip2 or the voltage Vp2 applied to the second oxygen pump cell 2 whose gain is temporarily changed, e.g., the Ip2 at the order of mA or the voltage Vp2 at the order of V.

[Third Embodiment]

The apparatus for measuring the NOx concentration outputs one or more, at a level other than a normal level, of a plurality of the analog signals which are output to an onboard system loading the apparatus for measuring the NOx concentration to measure the NOx concentration in the exhaust gas or the ECU in case where the abnormality generates in the apparatus for measuring the NOx concentration. Thereby the onboard system or the ECU can detect the abnormality of the apparatus for measuring the NOx concentration. Moreover, the apparatus for measuring the NOx concentration can report an abnormal part and/or abnormal state to the onboard system or the ECU by means of a combination of a plurality of the analog signals.

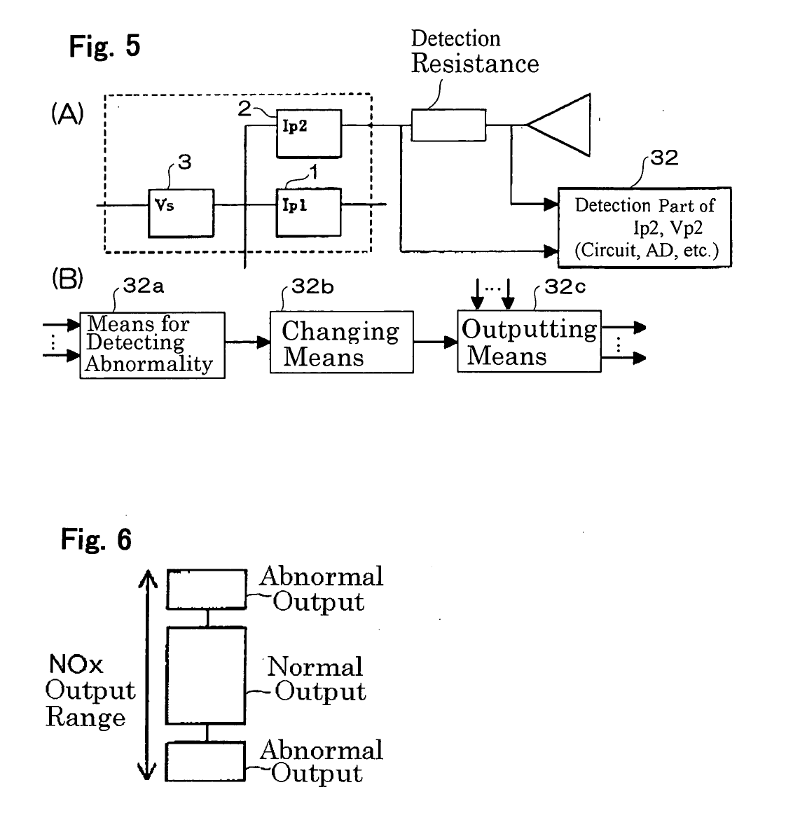

FIG. 6 is a figure to explain an example of constitution of a NOx output range in the apparatus for measuring the NOx concentration according to the third embodiment of the present invention.

The NOx concentration would be a positive number and not more than 500 ppm if a mixing ratio of combustible gas is normal and the catalyst(s) functions normally. Referring to FIG. 6, an output range of a NOx signal showing the NOx concentration is defined as −100-600 ppm, and the apparatus for measuring the NOx concentration is constituted so as to, in the normal case, output the NOx signal corresponding to 0-500 ppm of the NOx concentration, whereas, in the abnormal case, to output the NOx signal at a level corresponding to −100 or 600 ppm of the NOx concentration.

[Fourth Embodiment]

The apparatus for measuring the NOx concentration according to a fourth embodiment of the present invention has changing means for reporting the abnormal part of the apparatus for measuring the NOx concentration detected by the means for detecting the abnormality, by changing a code of a digital signal output at a predetermined code in case of the normality of the apparatus for measuring the NOx concentration, into a code outside the normal range, in case of the abnormality.

[Fifth Embodiment]

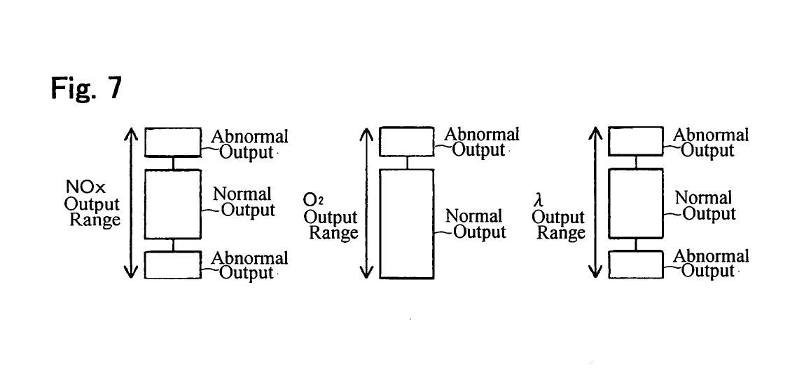

FIG. 7 is a figure to explain an example of constitution of a plurality of signals in the apparatus for measuring the NOx concentration according to a fifth embodiment of the present invention.

The apparatus for measuring the NOx concentration according to the present embodiment outputs one or more analog signals at a level outside a normal level, from among a plurality of analog signals output to the onboard system loading the apparatus for measuring the NOx concentration to measure the NOx concentration in the exhaust gas or the ECU in case where the abnormality generates in the apparatus for measuring the NOx concentration. Thereby the onboard system or the ECU can detect the abnormality of the apparatus for measuring the NOx concentration. Moreover, the apparatus for measuring the NOx concentration can report the abnormal part (or site) and/or the abnormal state to the onboard system or the ECU, by the combination of a plurality of the analog signals.

Referring to FIG. 7, in the present embodiment, the output range of the NOx signal is defined as the same as the third embodiment. Moreover, an output range of an O2 signal is defined as −20-30% of the oxygen concentration, and the apparatus for measuring the NOx concentration is constituted so as to, in the normal case, output the O2 signal showing the oxygen concentration of from 0% to atmospheric oxygen concentration at most, whereas, in the abnormal case, to output the O2 signal showing 30% of the oxygen concentration. Here, it is impossible to detect 30% of the oxygen concentration in the normal case because the atmospheric oxygen concentration is about 20%.

Further, an output range of a λ (lambda) signal is defined as from 0.9 to 1.1. The λ signal shows 0.95-1.05 λ in the normal case. Therefore, the apparatus for measuring the NOx concentration is constituted so as to defined the output range of the λ signal as 0.95-1.05 in the normal case, whereas to output the λ signal showing 0.9 or 1.1 in the abnormal case.

According to the present embodiment, 3 (3 kinds of the output of the NOx signal, including the output in the normal case)×2 (2 kinds of the output of the O2 signal, including the output in the normal case)×3 (3 kinds of the output of the λ signal, including the output in the normal case) minus 1 (the output in the normal case of all of the NOx signal, the O2 signal and the λ signal)=17 kinds of the abnormal contents can be reported.

[Sixth Embodiment]

An example of preferred constitution of the apparatus for measuring the NOx concentration according to the fifth embodiment will be described in detail.

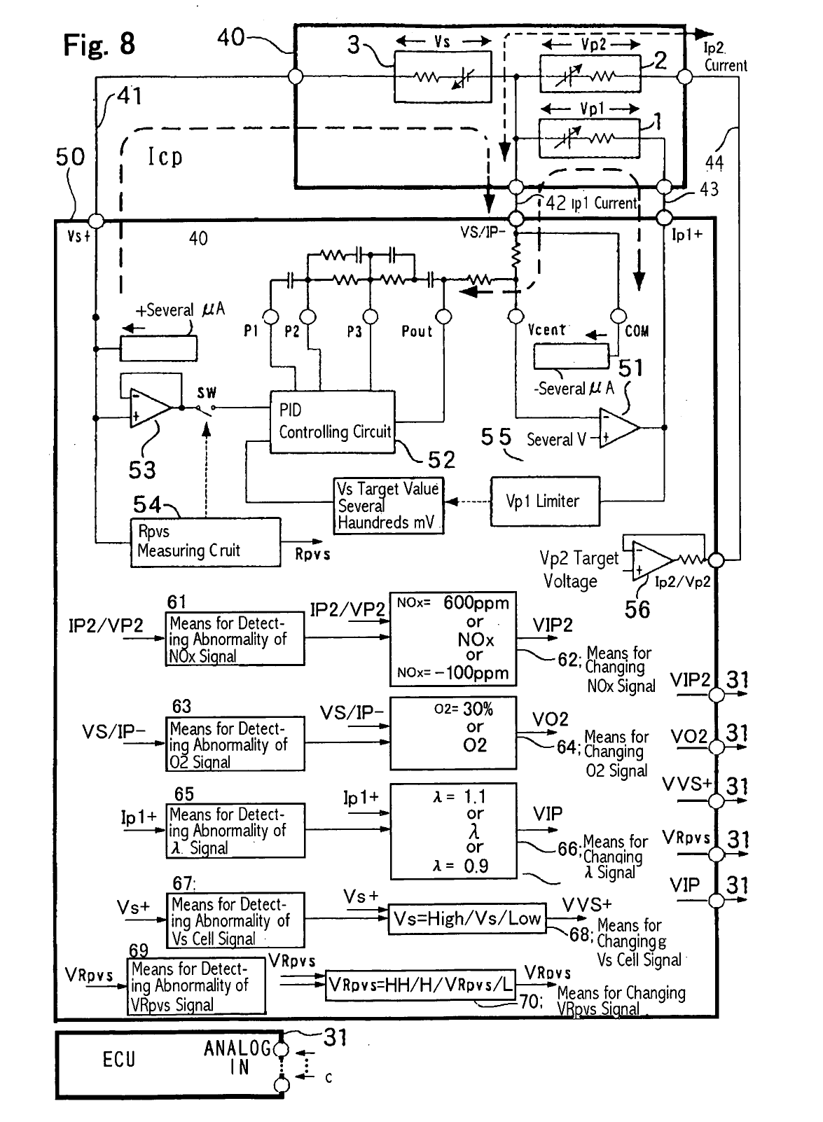

FIG. 8 is a schematic diagram to explain a circuit constitution of the apparatus for measuring the NOx concentration according to a sixth embodiment of the present invention.

Referring to FIG. 8, a controlling circuit of the sensor 50 mainly comprises the following units, i.e., an Ip1 driver 51, a PID controlling circuit 52, an operational amplifier 53, a Rpvs measuring circuit 54, a Vp1 limiter 55, an Ip2 driver 56, and means for detecting abnormality 61, 63, 65, 67, 69 and changing means 62, 64, 66, 68, 70, which make up a self-diagnosing circuit. The controlling circuit of the sensor 50 can be realized as an application specific IC (ASIC).

Output terminals VIP2, VO2 and VVS in the controlling circuit of the sensor 50 are connected to analog input terminals in the ECU 31.

A voltage in proportion to a current flowing across the second oxygen pump cell 2, i.e., an IP2 detection resistance voltage can be output to the VIP2 terminal.

A voltage in proportion to a current flowing across the first oxygen pump cell 1, i.e., a POUT terminal voltage can output to the VO2 terminal.

A voltage in proportion to a potential difference between the electrodes Vs+ and Vs− of the oxygen partial-pressure detection cell 3, i.e., a Vs+ terminal voltage can be output to the VVS terminal.

The Ip1 driver 51, in which an inverting input terminal is connected to a Vcent terminal, a non-inverting input terminal is connected to a reference voltage (several volts), and an output terminal is connected to an Ip1+ terminal, is an operational amplifier to flow the Ip1 current into the first oxygen pump cell 1. Thereby the Ip1 current is controlled so as to always maintain the electrical potential of the Vcent terminal at the reference voltage since the Ip1 driver 51 constitutes a negative feedback circuit. A pump current is controlled so as to keep electromotive force Vs at a controlling target value in cooperation with the PID controlling circuit, by controlling the voltage of the Vcent terminal at the reference voltage in this manner.

The PID controlling circuit 52 constitutes a PID operational circuit, together with resistances and capacitors connected to a P1 terminal, a P2 terminal and a P3 terminal, which are I/O signal wires of the ASIC for input and output. This PID controlling circuit 52 outputs a voltage, which is obtained by the PID operation from deviation volume ΔVs of the electromotive force Vs of the oxygen partial-pressure detection cell 3 against the Vs controlling target value, to the Pout terminal, whereby the Ip1 current from the Ip1 driver is controlled.

That is to say, the voltage obtained from a deviation quantity AVs by the PID operation is output to the Pout terminal so as to flow the Ip1 current to pump a shortfall of oxygen into by the first oxygen pump cell 1 since the partial pressure of oxygen in the first measurement chamber 5 is lower than reference partial pressure of oxygen in case where the electromotive force Vs of the oxygen partial-pressure detection cell 3 is higher than the Vs controlling target voltage. On the other hand, the voltage obtained from the deviation quantity AVs by the PID operation is output to the Pout terminal so as to flow the Ip1 current to pump out surplus oxygen by the first oxygen pump cell 1 since the partial pressure of oxygen in the first measurement chamber 5 is higher than the reference partial pressure of oxygen in case where the electromotive force Vs of the oxygen partial-pressure detection cell 3 is lower than the Vs controlling target voltage.

Negative several μA of a constant current source is connected with a COM terminal to be connected with a wire 42 in order to prevent an error of the PID operation by an Icp current.

That is to say, positive several μA of the constant current source is connected with the Vs+ terminal, thereby oxygen reference is created by supplying the Icp current into the oxygen partial-pressure detection cell 3. Accordingly, the operational error by the Icp current is prevented by connecting negative several pA of the constant current source to the COM terminal and deducting this several pA from the current flowing into the PID operational circuit.

Moreover, the operational amplifier 53 connected between the Vs+ terminal and the PID controlling circuit 52 constitutes a voltage follower circuit. Thereby the PID controlling circuit 52 appears to have higher impedance than the Vs+ terminal so that positive several μA of a supply current from the constant current source is restrained from flowing into the PID controlling circuit 52.

The Rpvs measuring circuit 54, which measures the temperature of the sensor element 40 from the internal resistance Rpvs of the oxygen partial-pressure detection cell 3, comprises the operational amplifier, the resistance, the capacitor and so on. This Rpvs measuring circuit 54 generates a change in the voltage corresponding to the internal resistance value of the oxygen partial-pressure detection cell correlating with the temperature of the element, by flowing a predetermined measuring current into the oxygen partial-pressure detection cell 3 every a predetermined time, and a VRpvs voltage changing in 0 to 4.5 V of a range can be obtained by operationally amplifying a variable of the voltage at both ends of the oxygen partial-pressure detection cell 3 obtained thereby, by a constant.

Connection between the PID controlling circuit 52 and the operational amplifier 53 is cut off by a switch SW between them so that the change in the voltage by means of the measuring current affects the output of the PID controlling circuit when the measuring current of the Rpvs measuring circuit 54 is flowed into the oxygen partial-pressure detection cell 3. Accordingly, the measurement by means of the Rpvs measuring circuit 54 is performed while the connection between the PID controlling circuit 52 and the operational amplifier 53 is cut off by the SW.

The Vp1 limiter 55 is a circuit to prevent, what is called, blackening of the first oxygen pump cell 1 and causes the Vs target value to shift in case where the voltage Vp1 at the both ends of the first oxygen pump cell 1 exceeds a fixed range. Here, “blackening” means a blackening phenomenon of a pump cell by loss of an oxygen ion.

The Ip2 driver 56, in which the Vp2 target voltage is input into a non-inverting input terminal (+) thereof and an inverting input terminal side thereof is connected with an output terminal side thereof, is an operational amplifier to flow the Ip2 current into the second oxygen pump cell 2. An Ip2/Vp2 terminal is connected with the output terminal via the detection resistance of the Ip2 current.

In this detection of the abnormality, it is preferred to judge whether there is abnormality or not when the air/fuel ratio is leanly controlled, because there are some cases where the abnormality can not be correctly detected since the state of the Ip1 or the Vs changes in case where the air/fuel ratio is in a rich state. Moreover, it is possible to perform the judgment of the abnormality detection in the ECU 31 according to circumstance, though, in this embodiment, the judgment is performed in the sensor controlling circuit 50.

The Ip2/Vp2 terminal voltage is input into the means for detecting the abnormality of the NOx signal 61, and the individual controlling signals are output in case where the Ip2/Vp2 terminal voltage is within a predetermined range, where the Ip2/Vp2 terminal voltage is below the predetermined range and where the Ip2/Vp2 terminal voltage is over the predetermined range, respectively. Further, the means for detecting the abnormality of the NOx signal 61 can also detects abnormality of a wire 44.

The means for changing the NOx signal 62 causes the Ip2/Vp2 terminal (means for outputting the NOx signal) to just output the Ip2/Vp2 terminal voltage or a voltage amplifying the Ip2/Vp2 terminal voltage in case where the Ip2/Vp2 terminal voltage is within a normal range, to output a voltage corresponding to NOx=−100 ppm in case where the Ip2/Vp2 terminal voltage is below the predetermined range and to output a voltage corresponding to NOx=600 ppm in case where the Ip2/Vp2 terminal voltage is over the predetermined range, based on the controlling signal output from the means for detecting the abnormality of the NOx signal 61.

A VS/IP− terminal voltage is input into the means for detecting the abnormality of the O2 signal 63, and individual controlling signals are output in case where the VS/IP− terminal voltage is within a normal range and where the VS/IP− terminal voltage is over the predetermined range, respectively.

The means for changing the O2 signal 64 causes the VS/IP− terminal (means for outputting the O2 signal) to just output the VS/IP− terminal voltage or a voltage amplifying the VS/IP− terminal voltage in case where the VS/IP− terminal voltage is within the normal range and to output a voltage corresponding to O2=30% in case where the VS/IP− terminal voltage is over the predetermined range, based on the controlling signal output from the means for detecting the abnormality of the O2 signal 63.

The Ip1+ terminal voltage (the λ signal) is input into the means for detecting the abnormality of the λ signal 65, and individual controlling signals are output in case where the Ip1+ terminal voltage is within a normal range, where the Ip1+ terminal voltage is below the predetermined range and where the Ip1+ terminal voltage is over the predetermined range, respectively.

The means for changing the λ signal 66 causes the Ip1+ terminal (means for outputting the λ signal) to output the Ip1+ terminal voltage or a voltage amplifying the Ip1+ terminal voltage in case where the Ip1+ terminal voltage is within a normal range, to output a voltage corresponding to λ=0.9 in case where the Ip1+ terminal voltage is below the predetermined range and to output a voltage corresponding to λ=1.1 in case where the Ip1+ terminal voltage is over the predetermined range, based on the controlling signal output from the means for detecting the abnormality of the λ signal 65.

A Vs+ terminal voltage is input into the means for detecting the abnormality of the Vs cell signal 67, and individual controlling signals are output in case where the Vs+ terminal voltage is within a normal range, where the Vs+ terminal voltage is below the predetermined range and where the Vs+ terminal voltage is over the predetermined voltage, respectively.

The means for changing the Vs cell signal 68 causes a VVS+terminal (means for outputting a VVS+ signal) to just output the Vs+terminal voltage or a signal amplifying the Vs+ terminal voltage (or a signal amplifying a signal corresponding to the Vs+ terminal voltage) in case where the Vs+ terminal voltage is within a normal range, to output a voltage corresponding to LOW in FIG. 8 in case where the Vs+ terminal voltage is below the predetermined voltage and to output a voltage corresponding to HIGH in FIG. 8 in case where the Vs+ terminal voltage is over the predetermined range, based on the controlling signal output from the means for detecting the abnormality of the Vs cell signal 67.

A VRpvs signal corresponding to the internal resistance Rpvs of the oxygen partial-pressure detection cell 3 measured by the VRpvs measuring circuit 54 is input into the means for detecting the abnormality of the VRpvs signal, and individual controlling signals are output in case where a level of the VRpvs signal is within a normal range, where the level of the VRpvs signal is below the predetermined range and where the level of the VRpvs signal is over the predetermined range, respectively.

The means for changing the VRpvs signal 70 causes the VRpvs terminal (means for outputting the VRpvs signal) to just output the VRpvs signal or a signal amplifying the VRpvs signal in case where the VRpvs signal is within a normal range, to output a voltage corresponding to L in FIG. 8 in case where the VS+ terminal voltage is below the predetermined range and to output a voltage corresponding to H or HH in FIG. 8 in case where the VS terminal voltage is over the predetermined range, based on the controlling signal output from the means for detecting the abnormality of the VRpvs signal 69.

According to this embodiment, the NOx signal corresponding to 0 ppm to 500 ppm of the NOx concentration is output in case where the NOx signal is normal, the level of the NOx signal corresponding to −100 ppm or 600 ppm of the NOx concentration in case where the NOx signal is abnormal, the O2 signal showing the oxygen concentration of from 0% to the atmospheric oxygen concentration at most is output in case where the O2 signal is normal, the O2 signal showing the oxygen concentration of 30% is output in case where the O2 signal is abnormal, and the λ signal showing 0.9 or 1.1 is output in case where the λ signal is abnormal.

Besides, the apparatus for measuring the NOx concentration according to the this embodiment may further comprise the means for detecting the abnormality of the VRpvs signal, which functions in the same manner as the means for detecting the abnormality of the signal and the means for changing the VRpvs signal, which functions in the same manner as the means for changing the λ signal.

[Seventh Embodiment]

The apparatus for measuring the NOx concentration according to seventh embodiment of the present invention will be described. The abnormality such as the short circuit of the battery and the short circuit of the ground can be detected since the voltage between the wires in the short circuit is similar to the voltage Vp2 applied to the second pump cell in case where a short circuit between, e.g., “a wire between the NOx detection cell (the Ip2 cell) and the controlling circuit” and “the other sensor wire” generates even if the detection gain is not caused to change in case where the abnormality is detected. The voltage Vp2 applied to the second pump cell is at the order of mV in the normal case, whereas the voltage Vp2 applied to the second pump cell is at the order of V, for example, in case where the abnormality such as the short circuit of the battery and the short circuit of the imaginary ground generates.

[Eighth Embodiment]

The apparatus for measuring the NOx concentration according to eighth embodiment of the present invention will be described.

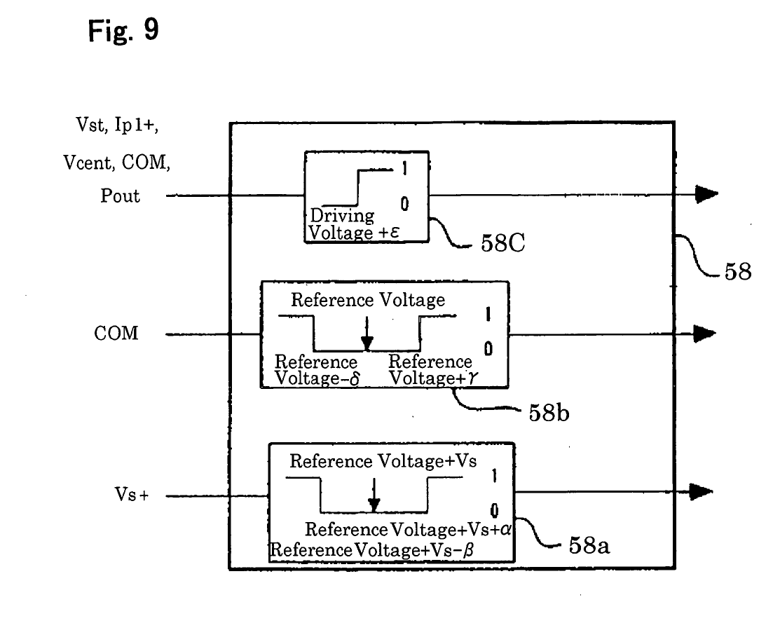

FIG. 9 is a figure to explain constitution of each means for detecting abnormality, which further applies to the apparatus for measuring the NOx concentration shown in FIG. 8.

Referring to FIG. 9, a self-diagnosing circuit (means for detecting abnormality) 58 mainly comprises window comparators 58a, 58b and a comparator 58c, and detects abnormality of four wires 41, 42, 43, 44 connected with three cells of a sensor element 40.

Namely, it judges by the window comparator 58a whether the electrical potential of the Vs+ terminal, e.g. of the ASIC, is within a predetermined range or not, and judges by the window comparator 58b whether the electrical potential of the VS/IP− terminal (the COM terminal) of the ASIC is within a predetermined range or not. Moreover, it judges by the comparator 58c whether the electrical potential of any one of terminals from among the Vs+ terminal, the Ip1+ terminal, the Vcent terminal, the VS/IP1− terminal (the COM terminal), the Ip2/Vp2 terminal and the Pout terminal of ASIC exceeds a predetermined value (the predetermined voltage) or not.

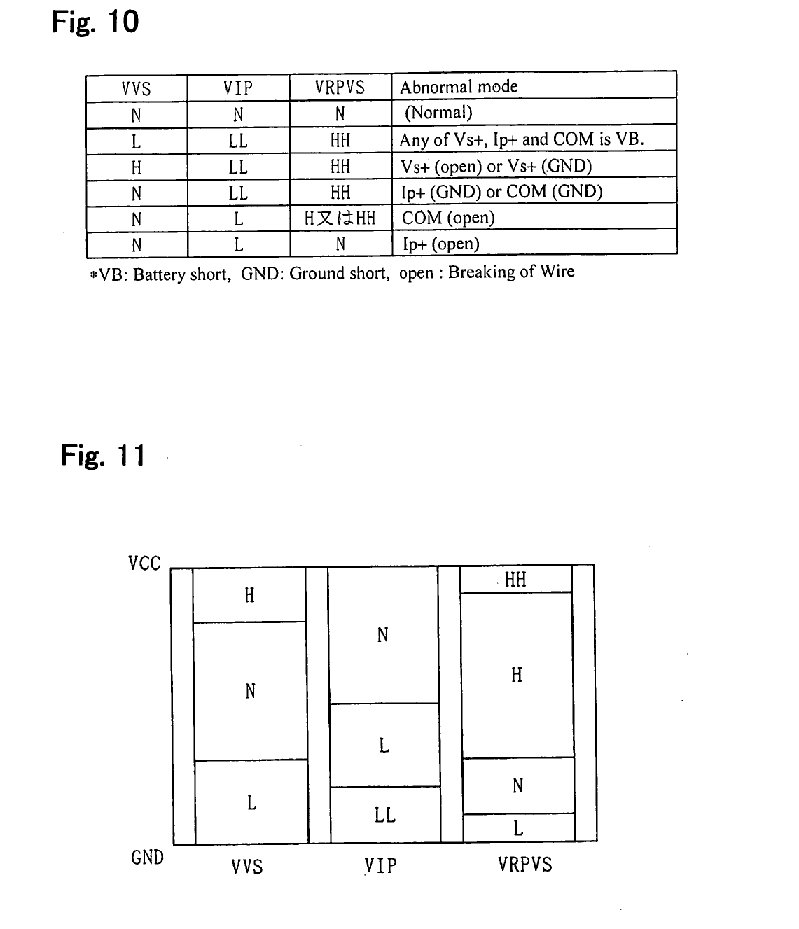

Referring to FIG. 10 and FIG. 11, the voltage of the VVS terminal and the VIP terminal is set to lower than a normal value and the voltage of the VRpvs terminal is set to higher than the normal value in case where the controlling signal based on the signal output from the window comparator 58a, 58c and the comparator 58c of the means for detecting the abnormality is received, for example, in case where any of the Vs terminal, the Ip1+ terminal and the VS/IP− terminal (the COM terminal) short-circuits the battery. The electrical potential shown in FIG. 10 and FIG. 11 is similarly set in case where any of the Vs+ terminal, the Ip1+ terminal and the COM terminal short-circuits with the ground or cuts off.

Moreover, the electrical potential of the Vs+ terminal usually maintains a value (the reference voltage+the electromotive force Vs) adding the electromotive force Vs of the oxygen partial-pressure detection cell 3 to the reference voltage of the VS/IP− terminal (the COM terminal). Therefore, the signal that the abnormality generates is given in case where the electrical potential of the Vs+ terminal rises over an upper limit V of the window comparator 58a, which is put as “the reference voltage+the electromotive force Vs+α”, or where the electrical potential of the Vs+ terminal descends below a lower limit, which is put as “the reference voltage+ the electromotive force Vs-β”.

Moreover, the electrical potential of the VS/IP− terminal (the COM terminal) is controlled by the Ip1 driver 51 so as to always maintain the reference voltage. Therefore, the signal that the abnormality generates is given in case where the electrical potential of the VS/IP− terminal (the COM terminal) rises over an upper limit of the window comparator 58b, which is put as “the reference voltage+y”, or where the electrical potential of the VS/IP− terminal (the COM terminal) descends below a lower limit, which is put as “the reference voltage−δ”.

Snapping of a wire in any terminal, short-circuiting with a source line of a battery, breaking down a element constituting a circuit and the like are considered as these abnormality.

Further, the comparator 58c judges whether each electrical potential of the Vs+ terminal, the Ip+ terminal, the Vcent terminal, the VS/IP− terminal (the COM terminal) and the Pout terminal of the ASIC exceeds a running voltage of the circuit in the ASIC or not. Each terminal is monitored by the comparator 58c, whose upper limit (the running voltage+ε) is put as a value estimating a voltage change of the running source and the like, and is judged that the abnormality that the terminal short-circuits to the source line of the battery generates in case where the electrical potential of any terminal rises over the upper limit, and thereby a signal gives.

It is preferred that this abnormality detection system judges whether there is any abnormality or not when an air/fuel ratio is leanly controlled. In the lean air/fuel ratio, the abnormality can be suitably detected since states of the Ip1+ and Vs+are stable. Moreover, the abnormality detection under the air/fuel ratio may be judged by the ECU 31.

[Ninth Embodiment]

The apparatus for measuring the NOx concentration according to ninth embodiment of the present invention will be described. The apparatus for measuring the NOx concentration according to the sixth embodiment of the present invention shown in FIG. 8 includes the Rpvs measuring circuit 54. The temperature of the sensor element can be measured by detecting element impedance (Rpvs) by means of the Rpvs measuring circuit 54. Abnormality of contact resistance generating between e.g., the NOx sensor element and the controlling circuit can be detected by the Rpvs measuring circuit 54.

The means for controlling the NOx sensor element or means for controlling a heater attached to the NOx sensor element controls the heater so as to keep element resistance at 150 Ω in case where, for example, the element resistance corresponding to the element temperature of a controlling target is 250 Ω and, for example, the contact resistance is about 100 Ω since electrical connection between the wire and the element is defective owing to bad manufacture. In this case, a NOx output largely changes and/or a level or order of the NOx output changes, as compared with in the case of no contact resistance. According to this feature, a delivery of a bad product is prevented by, for example, confirming the NOx output on a productive line. Further, in this apparatus, the abnormality regarding the Rpvs can be also detected.

The apparatus for measuring the NOx concentration according to the ninth embodiment of the present invention can output this abnormality of the element resistance further enlarging an extent of the change of a predetermined signal by means of the means for detecting the abnormality 61, 63, 65, 67, 69 and the changing means 62, 64, 66, 68, 70 shown in FIG. 8.

[Tenth Embodiment]

One example of circuit constitution of the means for detecting the abnormality 61, 63, 65, 67, 69 and the changing means 62, 64, 66, 68, 70 in the apparatus for measuring the NOx concentration according to the eighth embodiment of the present invention shown in FIG. 8 will be described. The means for detecting the abnormality of the Vs cell signal 67 and the means for changing the Vs cell signal 68 will be described in the present embodiment. The circuit constitution described in the present embodiment is, however, applicable to other means for detecting the abnormality and other changing means, respectively.

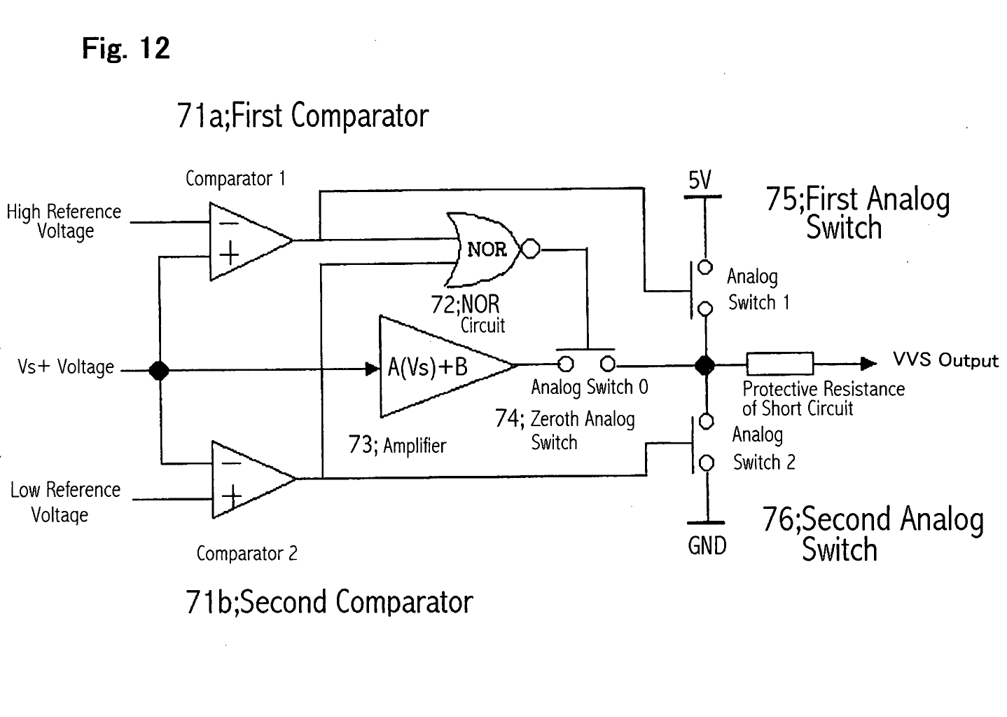

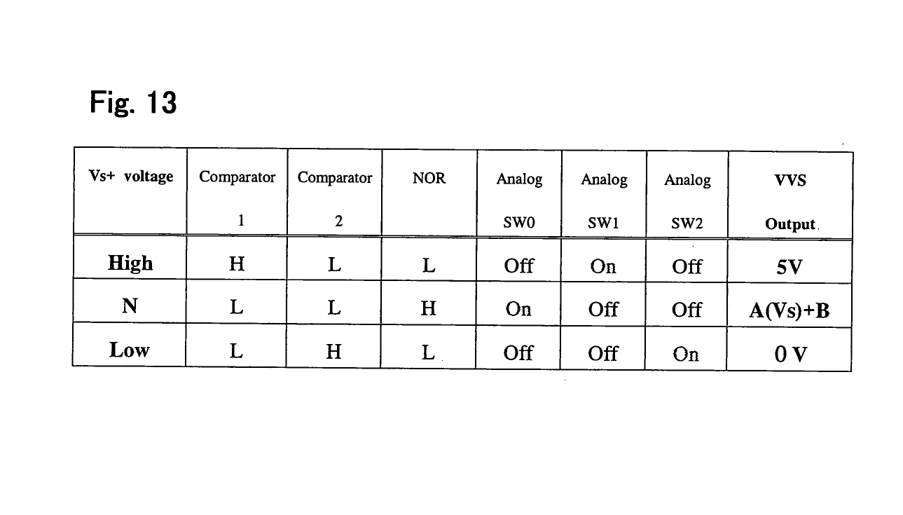

FIG. 12 is a figure to explain one example of the circuit constitution of the means for detecting the abnormality and the changing means which are applicable to the apparatus for measuring the NOx concentration shown in FIG. 8. FIG. 13 is a figure to show relation between an input signal and an output signal in the circuit shown in FIG. 12.

Referring to FIG. 12, the means for detecting the abnormality of the Vs cell signal 67 comprises a first comparator 71a, a second comparator 71b and a NOR circuit 73. The means for changing the Vs cell signal 68 comprises a zeroth analog switch 74, a first analog switch 75 and a second analog switch 76.

Operation of the circuit constitution shown in FIG. 12 will be described referring to FIG. 13. The first comparator 71a outputs High in case where the Vs+ voltage is within an abnormal higher range than a normal range. The second comparator 71b outputs High in case where the Vs+ voltage is within the abnormal lower range than the normal range.

In case where the Vs+ voltage (the Vs+ signal) is within the normal range, the first comparator 71a and the second comparator 71b outputs Low, the NOR circuit 73 outputs High, only the zeroth analog switch 74 is turned ON, and the predetermined terminal (a outputting means) outputs the untouched Vs+ voltage amplified by the amplifier 73. In case where the Vs+ voltage (the Vs signal) is within the abnormal higher range than the normal range, the first comparator 71a outputs High, the second comparator 71b outputs Low, only the first analog switch 75 is turned ON, and the predetermined terminal (the outputting means) outputs the untouched voltage of 5V. In case where the Vs+ voltage (the Vs+ signal) is within the abnormal lower range than the normal range, the first comparator 71a outputs Low, the second comparator 71b outputs High, only the second analog switch 76 is turned ON, and the predetermined terminal (the outputting means) outputs the untouched voltage of 0V.

### EFFECT OF THE INVENTION

According to the present invention, it is possible to provide an apparatus for measuring NOx concentration, an apparatus for self-diagnosing a NOx sensor and a self-diagnosing method thereof, which can precisely perceive a state of the NOx sensor suitably applied to NOx measurement in exhaust gas of an internal combustion engine and be applicable to onboard diagnosis (OBD).

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An apparatus for measuring NOx concentration comprising:
(a) a NOx sensor element having:
(a1) a first measurement chamber into which an analyte gas is introduced via a first diffusion resistance;
(a2) an oxygen partial-pressure detection cell which has a pair of electrodes provided on inside and outside of said first measurement chamber and detects oxygen concentration of the analyte gas in said first measurement chamber based on a potential difference between said pair of the electrodes;
(a3) a first oxygen pump cell which has a pair of electrodes provided on the inside and outside of said first measurement chamber and across which a current corresponding to the oxygen concentration of the analyte gas, referred to as “a first oxygen pump current”, hereinafter, flows by pumping the oxygen from the inside to the outside or vice versa of said first measurement chamber across said pair of the electrodes;
(a4) a second measurement chamber into which the analyte gas is introduced from said first measurement chamber via a second diffusion resistance; and
(a5) a second oxygen pump cell which has a pair of electrodes provided on the inside and outside of said second measurement chamber and across which a current corresponding to NOx concentration, referred to as “a second oxygen pump current”, hereinafter, flows across said pair of the electrodes by transferring oxygen dissociated by decomposition of nitrogen oxide in said second measurement chamber;
(b) means for controlling the oxygen partial-pressure detection cell which controls the oxygen concentration at the electrode provided on the outside of said oxygen partial-pressure detection cell;
(c) means for controlling the first oxygen pump cell which controls the oxygen concentration in said first measurement chamber by controlling said first oxygen pump current by application of a predetermined voltage to said first oxygen pump cell based on an output detected by said oxygen partial-pressure detection cell;
(d) means for controlling the second oxygen pump cell so as to cause said second oxygen pump current corresponding to the NOx concentration to flow by applying a predetermined voltage to said second oxygen pump cell;
(e) detection means for detecting said second oxygen pump current or the voltage applied to said second oxygen pump cell; and
(f) diagnostic means for diagnosing the apparatus for measuring the NOx concentration as normally functioning in case where the detected second oxygen pump current or the detected predetermined voltage applied to said second oxygen pump cell is within a predetermined range, whereas as not normally functioning in case where said current or said voltage is outside the predetermined range.

2. An apparatus for measuring NOx concentration comprising:
(a) a NOx sensor element having:
(a1) a first measurement chamber into which an analyte gas is introduced via a first diffusion resistance;
(a2) an oxygen partial-pressure detection cell which has a pair of electrodes provided on inside and outside of said first measurement chamber and detects oxygen concentration of the analyte gas in said first measurement chamber based on a potential difference between said pair of the electrodes;
(a3) a first oxygen pump cell which has a pair of electrodes provided on the inside and outside of said first measurement chamber and across which a current corresponding to the oxygen concentration of the analyte gas, referred to as “a first oxygen pump current”, hereinafter, flows by pumping the oxygen from the inside to the outside or vice versa of said first measurement chamber across said pair of the electrodes;
(a4) a second measurement chamber into which the analyte gas is introduced from said first measurement chamber via a second diffusion resistance; and
(a5) a second oxygen pump cell which has a pair of electrodes provided on the inside and outside of said second measurement chamber and across which a current corresponding to NOx concentration, referred to as “a second oxygen pump current”, hereinafter, flows across said pair of the electrodes by transferring oxygen dissociated by decomposition of nitrogen oxide in said second measurement chamber;
(b) means for controlling the oxygen partial-pressure detection cell which controls the oxygen concentration at the electrode provided on the outside of said oxygen partial-pressure detection cell;
(c) means for controlling the first oxygen pump cell which controls the oxygen concentration in said first measurement chamber by controlling said first oxygen pump current by application of a predetermined voltage to said first oxygen pump cell based on an output detected by said oxygen partial-pressure detection cell;
(d) means for controlling the second oxygen pump cell so as to cause said second oxygen pump current corresponding to the NOx concentration to flow by applying a predetermined voltage to said second oxygen pump cell;
(e) detection means for detecting a voltage applied to said oxygen partial-pressure detection cell; and
(f) diagnostic means for diagnosing the apparatus for measuring the NOx concentration as normally functioning in case where the detected voltage applied to said oxygen partial-pressure detection cell is within a predetermined range, whereas as not normally functioning in case where said voltage is outside the predetermined range.

3. An apparatus for measuring NOx concentration comprising:
(a) a NOx sensor element having:
(a1) a first measurement chamber into which an analyte gas is introduced via a first diffusion resistance;
(a2) an oxygen partial-pressure detection cell which has a pair of electrodes provided on inside and outside of said first measurement chamber and detects oxygen concentration of the analyte gas in said first measurement chamber based on a potential difference between said pair of the electrodes;
(a3) a first oxygen pump cell which has a pair of electrodes provided on the inside and outside of said first measurement chamber and across which a current corresponding to the oxygen concentration of the analyte gas, referred to as “a first oxygen pump current”, hereinafter, flows by pumping the oxygen from the inside to the outside or vice versa of said first measurement chamber across said pair of the electrodes;
(a4) a second measurement chamber into which the analyte gas is introduced from said first measurement chamber via a second diffusion resistance; and
(a5) a second oxygen pump cell which has a pair of electrodes provided on the inside and outside of said second measurement chamber and across which a current corresponding to NOx concentration, referred to as “a second oxygen pump current”, hereinafter, flows across said pair of the electrodes by transferring oxygen dissociated by decomposition of nitrogen oxide in said second measurement chamber;
(b) means for controlling the oxygen partial-pressure detection cell which controls the oxygen concentration at the electrode provided on the outside of said oxygen partial-pressure detection cell;
(c) means for controlling the first oxygen pump cell which controls the oxygen concentration in said first measurement chamber by controlling said first oxygen pump current by application of a predetermined voltage to said first oxygen pump cell based on an output detected by said oxygen partial-pressure detection cell;
(d) means for controlling the second oxygen pump cell so as to cause said second oxygen pump current corresponding to the NOx concentration to flow by applying a predetermined voltage to said second oxygen pump cell;
(e) detection means for detecting the electric potential at the inside electrode of said oxygen partial-pressure detection cell; and
(f) diagnostic means for diagnosing the apparatus for measuring the NOx concentration as normally functioning in case where the detected electric potential at the inside electrode of said oxygen partial-pressure detection cell is within a predetermined range, whereas as not normally functioning in case where said electric potential is outside the predetermined range.

4. An apparatus for measuring NOx concentration comprising:
(a) a NOx sensor element having:
(a1) a first measurement chamber into which an analyte gas is introduced via a first diffusion resistance;
(a2) an oxygen partial-pressure detection cell which has a pair of electrodes provided on inside and outside of said first measurement chamber and detects oxygen concentration of the analyte gas in said first measurement chamber based on a potential difference between said pair of the electrodes;
(a3) a first oxygen pump cell which has a pair of electrodes provided on the inside and outside of said first measurement chamber and across which a current corresponding to the oxygen concentration of the analyte gas, referred to as “a first oxygen pump current”, hereinafter, flows by pumping the oxygen from the inside to the outside or vice versa of said first measurement chamber across said pair of the electrodes;
(a4) a second measurement chamber into which the analyte gas is introduced from said first measurement chamber via a second diffusion resistance; and
(a5) a second oxygen pump cell which has a pair of electrodes provided on the inside and outside of said second measurement chamber and across which a current corresponding to NOx concentration, referred to as “a second oxygen pump current”, hereinafter, flows across said pair of the electrodes by transferring oxygen dissociated by decomposition of nitrogen oxide in said second measurement chamber;
(b) means for controlling the oxygen partial-pressure detection cell which controls the oxygen concentration at the electrode provided on the outside of said oxygen partial-pressure detection cell;
(c) means for controlling the first oxygen pump cell which controls the oxygen concentration in said first measurement chamber by controlling said first oxygen pump current by application of a predetermined voltage to said first oxygen pump cell based on an output detected by said oxygen partial-pressure detection cell;
(d) means for controlling the second oxygen pump cell so as to cause said second oxygen pump current corresponding to the NOx concentration to flow by applying a predetermined voltage to said second oxygen pump cell;
(e) detection means for detecting internal resistance of said oxygen partial-pressure detection cell; and
(f) diagnostic means for diagnosing the apparatus for measuring the NOx concentration as normally functioning in case where the detected internal resistance of said oxygen partial-pressure detection cell is within a predetermined range, whereas as not normally functioning in case where said internal resistance is outside the predetermined range.

5. An apparatus for measuring NOx concentration comprising:
(a) a NOx sensor element having:
(a1) a first measurement chamber into which an analyte gas is introduced via a first diffusion resistance;
(a2) an oxygen partial-pressure detection cell which has a pair of electrodes provided on inside and outside of said first measurement chamber and detects oxygen concentration of the analyte gas in said first measurement chamber based on a potential difference between said pair of the electrodes;
(a3) a first oxygen pump cell which has a pair of electrodes provided on the inside and outside of said first measurement chamber and across which a current corresponding to the oxygen concentration of the analyte gas, referred to as “a first oxygen pump current”, hereinafter, flows by pumping the oxygen from the inside to the outside or vise versa of said first measurement chamber across said pair of the electrodes;
(a4) a second measurement chamber into which the analyte gas is introduced from said first measurement chamber via a second diffusion resistance; and
(a5) a second oxygen pump cell which has a pair of electrodes provided on the inside and outside of said second measurement chamber and across which a current corresponding to NOx concentration, referred to as “a second oxygen pump current”, hereinafter, flows across said pair of the electrodes by transferring oxygen dissociated by decomposition of nitrogen oxide in said second measurement chamber;
(b) means for controlling the oxygen partial-pressure detection cell which controls the oxygen concentration at the electrode provided on the outside of said oxygen partial-pressure detection cell;
(c) means for controlling the first oxygen pump cell which controls the oxygen concentration in said first measurement chamber by controlling said first oxygen pump current by application of a predetermined voltage to said first oxygen pump cell based on an output detected by said oxygen partial-pressure detection cell;
(d) means for controlling the second oxygen pump cell so as to cause said second oxygen pump current corresponding to the NOx concentration to flow by applying a predetermined voltage to said second oxygen pump cell;
(e) detection means for detecting said first oxygen pump current or the voltage applied to said first oxygen pump cell; and
(f) diagnostic means for diagnosing the apparatus for measuring the NOx concentration as normally functioning in case where the detected first oxygen pump current or the detected predetermined voltage applied to said first oxygen pump cell is within a predetermined range, whereas as not normally functioning in case where said current or said voltage is outside the predetermined range.

6. The apparatus as defined in claim 1, wherein said apparatus is used for measuring the NOx concentration in an exhaust gas of an internal combustion engine.

7. The apparatus as defined in claim 1;
wherein said apparatus is used for measuring the NOx concentration in an exhaust gas of an internal combustion engine loaded on a vehicle, and
wherein onboard diagnosis (OBD) is performed by using the diagnostic result of said diagnostic means.

8. An apparatus for self-diagnosing a NOx sensor comprising:
(a) a NOx sensor element having
(a1) a first measurement chamber into which an analyte gas is introduced via a first diffusion resistance;
(a2) an oxygen partial-pressure detection cell which has a pair of electrodes provided on inside and outside of said first measurement chamber and detects oxygen concentration of the analyte gas in said first measurement chamber based on a potential difference between said pair of the electrodes;
(a3) a first oxygen pump cell which has a pair of electrodes provided on the inside and outside of said first measurement chamber and across which a current corresponding to the oxygen concentration of the analyte gas, referred to as “a first oxygen pump current”, hereinafter, flows by pumping oxygen from the inside to the outside or vice versa of said first measurement chamber via said pair of the electrodes;
(a4) a second measurement chamber into which the analyte gas is introduced from said first measurement chamber via a second diffusion resistance; and
(a5) a second oxygen pump cell which has a pair of electrodes provided on the inside and outside of said second measurement chamber and across which a current corresponding to NOx concentration, referred to as “a second oxygen pump current”, hereinafter, flows across said pair of the electrodes by transferring oxygen dissociated by decomposition of nitrogen oxide in said second measurement chamber; and
(b) means for controlling the NOx sensor element having
(b1) means for controlling the oxygen partial-pressure detection cell which controls the oxygen concentration at the electrode provided on the outside of said oxygen partial-pressure detection cell;
(b2) means for controlling the first oxygen pump cell which controls the oxygen concentration in said first measurement chamber by controlling said first oxygen pump current by application of a predetermined voltage to said first oxygen pump cell based on an output detected by said oxygen partial-pressure detection cell;
(b3) means for controlling the second oxygen pump cell so as to cause said second oxygen pump current corresponding to the NOx concentration to flow by applying a predetermined voltage to said second oxygen pump cell;
(b4) detection means for detecting said second oxygen pump current or the voltage applied to said second oxygen pump cell; and
(b5) means for diagnosing the NOx sensor which diagnoses the NOx sensor as normally functioning in case where the detected second oxygen pump current or the detected predetermined voltage applied to said second oxygen pump cell is within a predetermined range, whereas as not normally functioning in case where said current or said voltage is outside the predetermined range.

9. A method for self-diagnosing an apparatus for measuring NOx concentration comprising:
(a) a NOx sensor element having
(a1) a first measurement chamber into which an analyte gas is introduced via a first diffusion resistance;
(a2) an oxygen partial-pressure detection cell which has a pair of electrodes provided on inside and outside of said first measurement chamber and detects oxygen concentration of the analyte gas in said first measurement chamber based on a potential difference between said pair of the electrodes;
(a3) a first oxygen pump cell which has a pair of electrodes provided on the inside and outside of said first measurement chamber and across which a current corresponding to the oxygen concentration of the analyte gas, referred to as “a first oxygen pump current”, hereinafter, flows by pumping the oxygen from the inside to the outside or vice versa of said first measurement chamber across said pair of the electrodes;
(a4) a second measurement chamber into which the analyte gas is introduced from said first measurement chamber via a second diffusion resistance; and
(a5) a second oxygen pump cell which has a pair of electrodes provided on the inside and outside of said second measurement chamber and across which a current corresponding to NOx concentration, referred to as “a second oxygen pump current”, hereinafter, flows across said pair of the electrodes by transferring oxygen dissociated by decomposition of nitrogen oxide in said second measurement chamber; and
(b) means for controlling the NOx sensor element having
(b1) means for controlling the oxygen partial-pressure detection cell which controls the oxygen concentration at the electrode provided on the outside of said oxygen partial-pressure detection cell;
(b2) means for controlling the first oxygen pump cell which controls the oxygen concentration in said first measurement chamber by controlling said first oxygen pump current by application of a predetermined voltage to said first oxygen pump cell based on an output detected by said oxygen partial-pressure detection cell;
(b3) means for controlling the second oxygen pump cell so as to cause said second oxygen pump current corresponding to the NOx concentration to flow by applying a predetermined voltage to said second oxygen pump cell; and
(b4) detection means for detecting said second oxygen pump current or the voltage applied to said second oxygen pump cell;
wherein said means for controlling the NOx sensor element diagnoses the NOx sensor as normally functioning in case where the detected second oxygen pump current or the detected predetermined voltage applied to said second oxygen pump cell is within a predetermined range, whereas as not normally functioning in case where said current or said voltage is outside the predetermined range.

10. An apparatus for measuring NOx concentration which comprises a NOx sensor element having oxygen pump cells, a NOx detection cell and an oxygen partial-pressure detection cell, generates a gas in which oxygen partial-pressure is controlled from an analyte gas having oxygen concentration and nitrogen oxide concentration within a predetermined range, respectively, by said first oxygen pump cell and said oxygen partial-pressure detection cell, and measures the nitrogen oxide concentration in the analyte gas based on a limiting current to be flowed across said NOx detection cell contacting said gas whose oxygen partial-pressure is controlled;
wherein said apparatus for measuring the NOx concentration comprises:
means for detecting abnormality to detect abnormality of said first oxygen pump cell, said NOx detection cell and said oxygen partial-pressure detection cell; and
changing means for causing the apparatus for measuring the NOx concentration to output a predetermined signal whose level or order corresponds to the nitrogen oxide concentration within a predetermined range in said analyte gas in case where no abnormality is detected by said means for detecting the abnormality, whereas for changing the level or order of the predetermined signal in case where the abnormality of the apparatus for measuring the NOx concentration is detected by said means for detecting the abnormality.

11. The apparatus as defined in claim 10,
wherein said analyte gas includes the oxygen concentration within the predetermined range; and
wherein said changing means further causes said apparatus for measuring the NOx concentration to output the predetermined signal whose level or order corresponds to the oxygen concentration within the predetermined range in said analyte gas in case where no abnormality is detected by said means for detecting the abnormality, whereas said changing means change the level or order of the predetermined signal in case where the abnormality is detected by said means for detecting the abnormality.

12. The apparatus as defined in claim 10,
wherein said means for detecting the abnormality further detects abnormality of wiring connecting with said first oxygen pump cell, said NOx detection cell and said oxygen partial-pressure detection cell; and
wherein said changing means causes said apparatus for measuring the NOx concentration to output the predetermined signal whose level or order corresponds to the nitrogen oxide concentration within the predetermined range in said analyte gas in case where no abnormality of said wiring is detected by said means for detecting the abnormality, whereas said changing means change at least the level or order of the predetermined signal in case where the abnormality of said wiring is detected by said means for detecting the abnormality.

13. The apparatus as defined in claim 10,
wherein said means for detecting the abnormality detects the abnormality of the level or order of any one or more of;
(a) cell resistance of said oxygen partial-pressure detection cell whose resistance changes by temperature of said NOx sensor element and/or electrical potential of an electrode of said oxygen partial-pressure detection cell;
(b) a voltage applied to said first oxygen pump cell and/or a current flowing across said first oxygen pump cell; and
(c) a voltage applied to said second oxygen pump cell and/or a current flowing across said second oxygen pump cell.

14. The apparatus as defined in claim 10,
wherein said changing means is adapted to change the levels or orders of a plurality of the predetermined signals output by said apparatus for measuring the NOx concentration; and
an abnormal part and/or an abnormal state of said apparatus for measuring the NOx concentration are/is reported by a combination of said plurality of the predetermined signals.

15. The apparatus as defined in claim 10,
wherein said apparatus for measuring the NOx concentration is mounted on an onboard system in order to measure the nitrogen oxide concentration in exhaust gas; and
said means for detecting the abnormality and said changing means are located on a side of a controlling device in said onboard system.

16. The apparatus as defined in claim 10,
wherein the NOx censor element is used,
in which said oxygen pump cell and said oxygen partial-pressure detection cell are disposed facing space in a first chamber, and said NOx detection cell is disposed facing space in a second chamber; or
in which said oxygen pump cell is disposed facing the space in the first chamber, and said oxygen partial-pressure detection cell and said NOx detection cell are disposed facing the space of the second chamber.

17. An apparatus for measuring NOx concentration which comprises a NOx sensor element having oxygen pump cells, a NOx detection cell and an oxygen partial-pressure detection cell, generates a gas in which oxygen partial-pressure is controlled from an analyte gas having oxygen concentration and nitrogen oxide concentration within a predetermined range, respectively, by said first oxygen pump cell and said oxygen partial-pressure detection cell, and measures the nitrogen oxide concentration in the analyte gas based on a limiting current to be flowed across said NOx detection cell contacting said gas whose oxygen partial-pressure is controlled;
wherein said apparatus comprises:
means for detecting abnormality to detect an abnormal part of said apparatus for measuring the NOx concentration, and
changing means, in case of the abnormality of said apparatus for measuring the NOx concentration, for changing a level or order of one or more of analog signals output at a predetermined level or order in a normal case into a level or order which is not used in the normal case, thereby reporting the abnormal part of said apparatus for measuring the NOx concentration detected by said means for detecting the abnormality.

18. An apparatus for measuring NOx concentration which comprises a NOx sensor element having oxygen pump cells, a NOx detection cell and an oxygen partial-pressure detection cell, generates a gas in which oxygen partial-pressure is controlled from an analyte gas having oxygen concentration and nitrogen oxide concentration within a predetermined range, respectively, by said first oxygen pump cell and said oxygen partial-pressure detection cell, and measures the nitrogen oxide concentration in the analyte gas based on a limiting current to be flowed across said NOx detection cell contacting said gas whose oxygen partial-pressure is controlled;
wherein said apparatus comprises:
means for detecting abnormality to detect an abnormal part of said apparatus for measuring the NOx concentration, and
changing means, in case of the abnormality of said apparatus for measuring the NOx concentration, for changing a code of a digital signal output at a code within a predetermined range in a normal case into a code not used in the normal case, thereby reporting the abnormal part of said apparatus for measuring the NOx concentration detected by said means for detecting the abnormality.

19. An apparatus for measuring NOx concentration which comprises a NOx sensor element having oxygen pump cells, a NOx detection cell and an oxygen partial-pressure detection cell, generates a gas in which oxygen partial-pressure is controlled from an analyte gas having oxygen concentration and nitrogen oxide concentration within a predetermined range, respectively, by said first oxygen pump cell and said oxygen partial-pressure detection cell, and measures the nitrogen oxide concentration in the analyte gas based on oxygen-concentration-cell-electromotive-force generated by said NOx detection cell contacting said gas whose oxygen partial-pressure is controlled;
wherein said apparatus for measuring the NOx concentration comprises:
means for detecting abnormality to detect abnormality of said first oxygen pump cell, said NOx detection cell and said oxygen partial-pressure detection cell; and
changing means for causing the apparatus for measuring the NOx concentration to output a predetermined signal whose level or order corresponds to the nitrogen oxide concentration within a predetermined range in said analyte gas in case where no abnormality is detected by said means for detecting the abnormality, whereas for changing the level or order of the predetermined signal in case where the abnormality of the apparatus for measuring the NOx concentration is detected by said means for detecting the abnormality.

20. A method for self-diagnosing an apparatus for measuring NOx concentration,
wherein said apparatus comprises a NOx sensor element having oxygen pump cells, a NOx detection cell and an oxygen partial-pressure detection cell, generates a gas in which oxygen partial-pressure is controlled from an analyte gas having oxygen concentration and nitrogen oxide concentration within a predetermined range, respectively, by said first oxygen pump cell and said oxygen partial pressure detection cell, and measures the nitrogen oxide concentration in the analyte gas based on a limiting current to be flowed across said NOx detection cell contacting said gas whose oxygen partial-pressure is controlled, or on electric potential of said NOx detection cell; and
wherein a predetermined signal corresponding to the nitrogen oxide concentration within a predetermined range in said analyte gas is output in case where said apparatus for measuring the NOx concentration is normal, whereas at least said predetermined signal is changed based on a predetermined manner, followed by reporting an abnormal part of said apparatus for measuring the NOx concentration in case where abnormality of said apparatus for measuring the NOx concentration is detected.
